(19) United States
(12) Patent Application Publication
(10) Pub. No.: US 2009/0096204 A1
(43) Pub. Date: Apr. 16, 2009

(54) Pocket Isometric Pad

(76) Inventor: John Walker, Rowlett, TX (US)

Correspondence Address: WILSON DANIEL SWAYZE, JR., 3804 CLEARWATER CT., PLANO, TX, 75025, US

(21) Appl. No.: 11/870,131

(22) Filed: Oct. 10, 2007

(51) Int. Cl. B42D 1/02

(52) U.S. Cl. 283/45

(57) ABSTRACT

A notepad includes a sheet in the notepad having a first line in a first direction, a second line in a second direction, and a third line in a third direction. The first line, the second line and the third line may form an isometric pattern, and the first line is in a first direction. The second line may be in a second direction, and the third line may be in a third direction. The first line may be substantially perpendicular to the second line, and the third line may be substantially perpendicular to a edge of the sheet. The notepad may include a cover having indicia, and the indicia may include special offset solutions, and the indicia may include conversion constants. The indicia may include decimal equivalents to a fraction chart, and the indicia may include piping angles and solutions to the piping angles. The indicia may include pipe circumferences divided into equal parts, and the indicia may include dimensions and formulas for welded fittings.

### FIELD OF THE INVENTION

This invention relates in general to a writing pad and writing pad accessories, and in particular to a writing pad that includes isometric paper and helpful indicia.

### BACKGROUND OF THE INVENTION

A typical writing pad or tablet has a stiff laminated cardboard backing and a number of sheets of paper attached to it along the top edge by a binding. These types of writing pads are often used to take notes and messages while using the telephone or away from the office or desk. Most typical writing pads have only horizontal lines which are adequate for taking messages.

However, there is a need for being able to draw three-dimensional objects on two-dimensional paper. In order to facilitate this need, unbound isometric paper has been used. However, unbound isometric paper is inconvenient for use in the field on construction projects.

U.S. Pat. No. 4,973,184 discloses a writing pad organizer which includes a back flap and a front flap which are connected together through a spine. The front flap is capable of being interlocked with the back flap to hold such in a closed position. The front flap is capable of being hingedly moved relative to the back flap to expose an interior compartment located within the inner surface of both the front flap and the back flap. The interior surface of the back flap is to include a plurality of file folders with the interior surface of the front flap including a plurality of separate note pads. The sheets of the note pads can be removed and adhered to the file folders at designated areas.

U.S. Pat. No. 6,935,659 discloses a pouch or holder which has a friction-enhanced surface. The pouch has an opening to receive a cardboard backing of a writing pad. The sheets of paper of the writing pad overlie the upper surface of the pouch. The friction-enhanced material is located at the lower surface of the pouch. The pouch is closed at the bottom end and the side edges. The binding of the writing pad locates on the outside of the pouch.

### SUMMARY

A notepad includes a sheet in the notepad having a first line in a first direction, a second line in a second direction, and a third line in a third direction.

The first line, the second line and the third line may form an isometric pattern, and the first line is in a first direction.

The second line may be in a second direction, and the third line may be in a third direction.

The first line may be substantially perpendicular to the second line, and the third line may be substantially perpendicular to a edge of the sheet.

The notepad may include a cover having indicia, and the indicia may include special offset solutions, and the indicia may include conversion constants.

The indicia may include decimal equivalents to a fraction chart, and the indicia may include piping angles and solutions to the piping angles.

The indicia may include pipe circumferences divided into equal parts, and the indicia may include dimensions and formulas for welded fittings.

### BRIEF DESCRIPTION OF DRAWINGS

The invention may be understood by reference to the following description taken in conjunction with the accompanying drawings, in which, like reference numerals identify like elements, and in which:

FIG. 1 illustrates a notepad of the present invention;

FIG. 2 illustrates a notepad sheet of the present invention;

FIG. 3 illustrates a front cover/back cover of the present invention.

### DETAILED DESCRIPTION

Isometric paper has been bound into a notepad. The design allows Supervision Engineers and Craftsmen in the field to design and make changes to piping systems and their appurtenances fully dimensioned for fabrication and installation. The pocket pad enables record keeping of what was agreed upon in the system installation. There is no need to worry about the notepad paper becoming scattered and potentially lost when used in the field. The sheets of isometric notepad paper are detachedly bound together so that they can be removed only when the user desires to remove the notepad paper from the notepad. The notepad may have covers on the front and back, only on the front or only on the back. The notepad has parallel upper and lower supporting surfaces that are joined at an end. The sheets of paper of the writing pad overlie the upper surface.

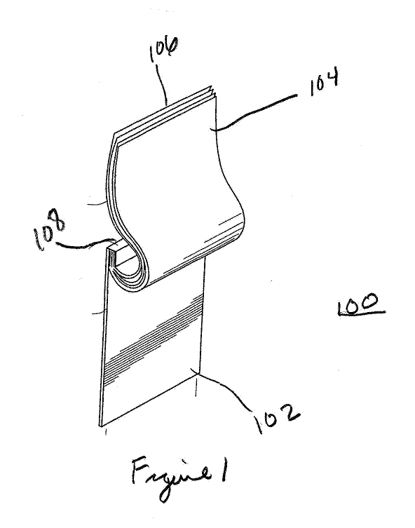

FIG. 1 illustrates a notepad 100 which includes a back cover 102 which may be flexible or rigid depending upon the needs of the user of the notepad 100. The notepad 100 may include a front cover 106 and isometric sheets 104 between the front cover 106 and the back cover 102 the isometric sheets 104 may be rectangular or any other suitable shape and is shown as being coextensive with each other. The notepad 100 includes a binding apparatus 108 to bind the front cover 106, the back cover 102 and the isometric sheets 104 together. The binding apparatus may include glue, rings or guides so that the individual isometric sheets 104 may be retained within the notepad 100 and yet be free to moved so that another isometric sheet 104 could be accessed.

A notepad includes a sheet in the notepad and characterized by three equal axes at right angles. One axis is vertical, the other two are inclined 30 degrees from the horizontal.

The sheet also consists of three sets of parallel lines. One set of lines are vertical, a second set inclined 30 degrees from the horizontal, the third set inclined at 150 degrees, measuring positive counterclockwise from a horizontal line. The resulting grid is based on 0.25 inch spacing.

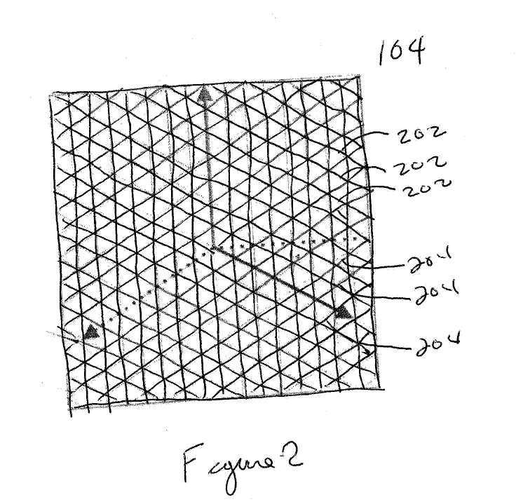

Isometric refers to a geometric system of three axes substantially lying at substantially right angles to each other. FIG. 2 illustrates an isometric sheet 104 which includes indicia including a first line 202, a second line 204 a third line 206 to form an isometric pattern. The first line 202 in a first direction, the second line 204 in a second direction and the third line 206 in a third direction substantially extend across the isometric sheet 104. The first line 202 is formed at a first angle and subsequent adjacent first line 202 is substantially parallel. The second line 204 is formed at a second angle and is substantially perpendicular to the first line of 202. Subsequent adjacent second line 204 is substantially parallel to the second line 204. The third line 206 is substantially vertical to the bottom edge of the isometric sheet 104 and extends through the intersection of the first line 202 and the second line 204.

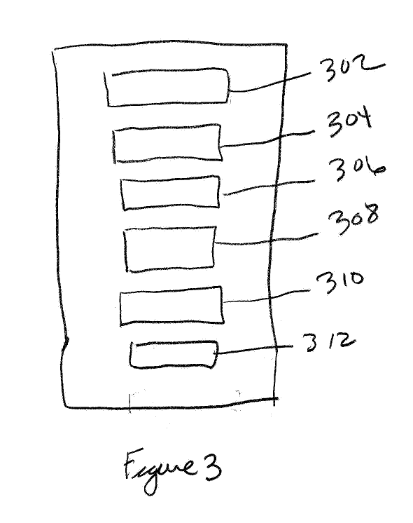

FIG. 3 illustrates the indicia which may be found on the inside of either the front cover or the back cover. The first indicia 302 may be special offset solutions, and the second indicia 304 may be conversion constants. The third indicia 306 may be decimal equivalents to fraction chart, and the fourth indicia 308 may be common piping angles and their solutions. The fifth indicia 310 may be pipe circumferences which have been divided into equal parts and the sixth indicia 312 may be general dimensions and formulas for welded fittings. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A notepad, comprising:
a sheet in the notepad including;
a first line in a first direction,
a second line in a second direction, and
a third line in a third direction.

2) A notepad as in claim 1, wherein the first line, the second line and the third line form an isometric pattern.

3) A notepad as in claim 1, wherein the first line is in a first direction.

4) A notepad as in claim 1, wherein the second line is in a second direction.

5) A notepad as in claim 1, wherein the third line is in a third direction,

6) A notepad as in claim 1, wherein the first line is substantially perpendicular to the second line.

7) A notepad as in claim 6, wherein the third line is substantially perpendicular to a edge of the sheet.

8) A notepad as in claim 1, wherein the notepad includes a cover having indicia.

9) A notepad as in claim 8, wherein the indicia includes special offset solutions.

10) A notepad as in claim 8, wherein the indicia includes conversion constants.

11) A notepad as in claim 8, wherein the indicia includes decimal equivalents to a fraction chart.

12) A notepad as in claim 8, wherein the indicia includes piping angles and solutions to the piping angles.

13) A notepad as in claim 8, wherein the indicia includes pipe circumferences divided into equal parts.

14) A notepad as in claim 8, wherein the indicia includes dimensions and formulas for welded fittings.
